(19) United States
(12) Patent Application Publication
(10) Pub. No.: US 2025/0232051 A1
(43) Pub. Date: Jul. 17, 2025

(54) DATA MANAGEMENT METHOD AND APPARATUS, SERVER AND STORAGE MEDIUM

(71) Applicant: Beijing Youzhuju Network Technology Co., Ltd., Pinggu District, Beijing (CN)

(72) Inventor: Zishuo Liu, Beijing (CN)

(21) Appl. No.: 18/850,755

(22) PCT Filed: Mar. 14, 2023
(86) PCT No.: PCT/CN2023/081218

§ 371 Date: Sep. 25, 2024

(30) Foreign Application Priority Data
Apr. 6, 2022 (CN) 202210359812.X

(51) Int. Cl. G06F 21/62

(52) U.S. Cl. CPC G06F 21/6218

(57) ABSTRACT

Disclosed in the embodiments of the present disclosure are a data management method and apparatus, a server and a storage medium. The method includes: acquiring a data acquisition request sent by a third-party application, wherein the data acquisition request includes token information of a first user and identification information of an access object; verifying the token information of the first user, and in response to determining that the token information passes verification, determining, according to the identification information of the access object, whether the access object has an association relationship with the first user; and on the basis of a determination result that the access object and the first user have an association relationship, sending service data of the access object to the third-party application.

The present disclosure claims priority of the Chinese patent application No. 202210359812.X, filed with the China Patent Office on Apr. 6, 2022, the entire contents of which are incorporated into the present disclosure by reference.

### TECHNICAL FIELD

Embodiments of the present disclosure relate to the field of electronic commerce (e-commerce), for example, to a data management method, an apparatus, a server, and a storage medium.

### BACKGROUND

With the continuous development of network technologies, e-commerce platforms become important channels for selling goods, in order to facilitate the business management, buyers and sellers often use a third-party application to manage business data.

Seller users authorize the third-party application, such as an Enterprise Resource Planning (ERP) application, in an open platform of the e-commerce platform, so that the third-party application has seller permissions, after the third-party application is connected to the open platform, the open platform verifies the seller permissions of the third-party application, so that the third-party application has a permission to acquire seller business data, and the sellers may manage the business data by the third-party application; and buyer users may also manage the business data by the corresponding third-party application in the above authorization and access modes.

However, this verification mode requires the users to open functional permissions in an account dimension to the third-party application, which makes the third-party application have the same business management permissions as the users, and the users' personal information has a significant security risk, at the same time, when the permission verification is performed on the open platform, each time of the verification requires account query by a database, so as to verify user accounts used by the third-party application, and the verification efficiency is relatively low.

### SUMMARY

The present disclosure provides a data management method, an apparatus, a server, and a storage medium, so as to achieve transmission of business data between an open platform and a third-party application by Token information verification and identification information verification of an access object.

In a first aspect, the embodiments of the present disclosure provide a data management method, which includes:
acquiring a data acquisition request sent from a third-party application; wherein the data acquisition request includes Token information of a first user and identification information of an access object;
verifying the Token information of the first user, in response to that the Token information passes a verification, according to the identification information of the access object, determining whether the access object has an association relationship with the first user; and
based on a determining result that the access object has the association relationship with the first user, sending business data of the access object to the third-party application.

In a second aspect, the embodiments of the present disclosure provide a data management apparatus, which includes:
a data request acquiring module, configured to acquire a data acquisition request sent
from a third-party application; wherein the data acquisition request includes Token information of a first user and identification information of an access object;
a verification executing module, configured to verify the Token information of the first
user, in response to that the Token information passes a verification, according to the identification information of the access object, determine whether the access object has an association relationship with the first user; and
a business data sending module, configured to, based on a determining result that the access object has the association relationship with the first user, send business data of the access object to the third-party application.

In a third aspect, the embodiments of the present disclosure provide a server, which includes a memory, a processing apparatus, and a computer program stored in the memory and can be run in the processing apparatus, the data management method according to any one of embodiments of the present disclosure is implemented in the case where the processing apparatus executes the program.

In a fourth aspect, the embodiments of the present disclosure provide a storage medium containing a computer executable instruction, the data management method according to any one of embodiments of the present disclosure is implemented in the case where the computer executable instruction is executed by a computer processor.

### BRIEF DESCRIPTION OF DRAWINGS

Throughout the drawings, the same or similar reference numbers refer to the same or similar elements. It is understood that the drawings are schematic and that components and elements are not necessarily drawn to scale.

FIG. 1 is a flow diagram of an embodiment of a data management method of the present disclosure;

FIG. 2 is a flow diagram of another embodiment of a data management method of the present disclosure;

FIG. 3 is a flow diagram of another embodiment of a data management method of the present disclosure;

FIG. 4 is a flow diagram of another embodiment of a data management method of the present disclosure;

FIG. 5 is a structure block diagram of a data management apparatus in the embodiment of the present disclosure; and

FIG. 6 is a structure block diagram of a server in the embodiment of the present disclosure.

### DETAILED DESCRIPTION

It should be understood that the steps described in the method embodiments of the present disclosure may be performed in a different order and/or in parallel. Furthermore, method embodiments may include additional steps and/or omit performing the illustrated steps. The scope of the present disclosure is not limited in this respect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that the modifications of “one” and “more” mentioned in the present disclosure are schematic rather than restrictive, and those skilled in the art should understand that unless otherwise explicitly stated in the context, it should be understood as “one or more”.

Names of messages or information exchanged among multiple apparatuses in the embodiment of the present disclosure are only configured for illustrative purposes, and are not configured to limit the scope of these messages or information.

It can be understood that before using the technical solutions disclosed in the embodiments of this disclosure, users should be informed of the type, using scope, using scenario, etc. of the personal information involved in this disclosure in an appropriate manner in accordance with relevant laws and regulations and obtain the user's authorization.

For example, in response to receiving an active request from a user, a prompt message is sent to the user to clearly remind the user that the operation requested will require the acquisition and use of the user's personal information. Therefore, the user can autonomously choose whether to provide personal information through software or hardware such as electronic devices, applications, servers or storage media that perform the operations of the technical solution of the present disclosure according to the prompt information.

As an example implementation, in response to receiving an active request from a user, the prompt information may be sent to the user in the form of a pop-up window, and the prompt information may be presented in the form of text in the pop-up window. In addition, the pop-up window can further contain a selection control for the user to choose “agree” or “disagree” to provide personal information to the electronic device.

It can be understood that the above processes of notification and acquiring user authorization are only illustrative and do not limit the implementation of present disclosure, other methods that meet relevant laws and regulations can further be applied to the implementation of present disclosure.

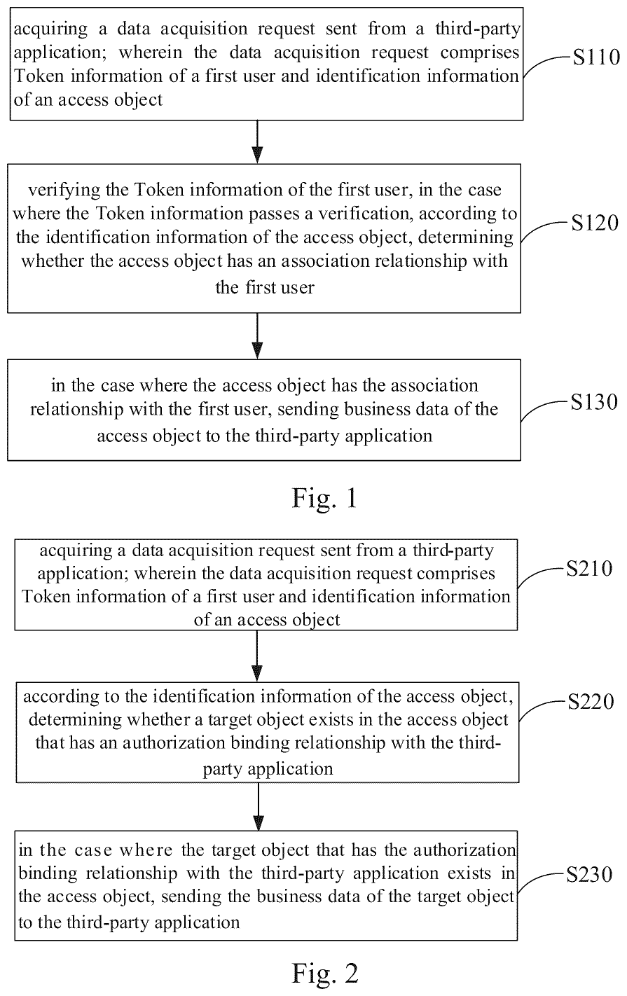

FIG. 1 is a flow diagram of an embodiment of a data management method of the present disclosure, this embodiment may be applied to achieve transmission of business data between an open platform and a third-party application by Token information verification and identification information verification of an access object, this method may be executed by a data management apparatus in an embodiment of the present disclosure, the apparatus may be implemented by software and/or hardware and integrated in a server carrying the open platform, and the method specifically includes the following steps.

S110, acquiring a data acquisition request sent from a third-party application, in which the data acquisition request includes Token information of a first user and identification information of an access object.

The third-party application is application software developed by the third party, in addition to the e-commerce platform and the first user (including a seller user and a buyer user), and the function of the third-party application is to access the open platform of the e-commerce platform, to acquire business data of a designated user in the e-commerce platform; the first user may authorize the third-party application in the open platform, acquire own business data in the e-commerce platform by the third-party application, and then manage the business data in the e-commerce platform by means of the third-party application; and in the case where the third-party application is respectively connected to open platforms of a plurality of e-commerce platforms, the first user may use the third-party application to achieve unified management of the business data in the plurality of the e-commerce platforms, and thereby improving the management efficiency of the business data.

A developer of the third-party application (that is, a third-party developer) who completes settlement in the open platform of the e-commerce platform and applies for an application development qualification, may go live in the open platform in the form of the third-party application (such as an Enterprise Resource Planning (ERP) application) by corresponding business development; in order for the third-party application to acquire user business data, the user needs to authorize the third-party application in the open platform, and the third-party application authorized acquires Token information of the user; in the case where the third-party application sends an acquisition request for the business data of a certain user to the open platform, the Token information of the user may be added to the data acquisition request; herein, Token is an identity identifier returned by the e-commerce platform to the user after the user logins in the e-commerce platform for the first time, so that account and password verification is replaced by Token verification; and compared to the account and password verification, the server needs to query account and password from a database and compare, while the Token information is usually stored in a memory of the server, the verification speed is fast, so that the frequent query of the database is avoided, the operating pressure of the server is reduced, and the third-party application is further avoided from knowing the user's account and password, which may lead to a potential security risk.

The seller user may open one or more stores in the e-commerce platform, and the store may exist in a form of a virtual store or a physical store. In the embodiments of the present disclosure, in the case where the seller user authorizes the third-party application, the stores (that is, the store opened by the seller user) having association relationships may be bound to the third-party application, and all or some of the stores are managed by the third-party application. Therefore, in the case where the third-party application sends the data acquisition request to the open platform, identification information of the store to be accessed is added as a request parameter to the data acquisition request; the buyer user may have one or more purchase orders in the e-commerce platform, when the buyer user authorizes the third-party application, the orders (that is, the purchase orders of the buyer user) having association relationships may be bound to the third-party application, and some or all of the orders are managed by the third-party application. Therefore, in the case where the third-party application sends the data acquisition request to the open platform, identification information (such as an order number) of the order to be accessed is added as a request parameter to the data acquisition request.

S120, verifying the Token information of the first user, in the case where the Token information passes the verification, according to the identification information of the access object, determining whether the access object has an association relationship with the first user.

When the open platform verifies the Token information of the first user in the data acquisition request, the Token information stored in the memory is acquired, and the validity of the Token information of the first user is verified by comparison, in the case where the Token information does not pass the verification, the data acquisition request is not responded; in the case where the Token information passes the verification, the identification information of the access object is sequentially verified, so as to verify whether the object to be accessed has an association relationship with an active user; for the seller user, this includes verifying whether the store to be accessed has an ownership relationship with the seller user, and whether the seller user has a management permission for the store, so as to achieve permission verification in a store dimension; and for the buyer user, this includes verifying whether the order to be accessed has an ownership relationship with the buyer user, and whether the buyer user has a management permission for the order, so as to achieve permission verification in an order dimension.

Optionally, in the embodiment of the present disclosure, after the data acquisition request sent from the third-party application is acquired, the method further includes at least one of the following: acquiring a sending region of the data acquisition request, and determining whether the sending region is a designated region; in the case where the sending region is not the designated region, not responding to the data acquisition request; acquiring a belonging region of the access object, and determining whether the belonging region of the access object is the designated region; in the case where the belonging region of the access object is not the designated region, not responding to the data acquisition request; acquiring an IP address of the data acquisition request, and determining whether the IP address is located in an address whitelist; and in the case where the IP address is not located in the address whitelist, not responding to the data acquisition request.

For example, the e-commerce platform provides a sale channel for goods or services to the users within a certain region range, and for the convenience of management, the e-commerce platform only provides corresponding data services for the third-party application, stores, and orders within the region; after the server integrated with the third-party application sends the data acquisition request, the open platform acquires the IP address of the server and determines whether the region where the server is located is the business region (that is, the designated region) of the e-commerce platform according to the IP address, or determines whether the region where the server is located is the designated region of the e-commerce platform according to a region identifier of the sending region added in the data acquisition request; in the case where the region where the server is located is the designated region of the e-commerce platform, the subsequent Token information verification of the first user and the identification information verification of the access object are sequentially performed; in the case where the region where the server is located is not the designated region of the e-commerce platform, this data acquisition request is not responded; similarly, after the identification information of the access object is acquired, according to the region where the access object is located, whether the accessed store is located in the business region of the e-commerce platform is determined, or whether the store of the seller party in the accessed order is located in the business region of the e-commerce platform is determined; in the case where the accessed store is located in the business region of the e-commerce platform, or the store of the seller party in the accessed order is located in the business region of the e-commerce platform, the subsequent identification information verification of the access object is sequentially performed; in the case where the accessed store is not located in the business region of the e-commerce platform, and the store of the seller party in the accessed order is not located in the business region of the e-commerce platform, this data acquisition request is not responded; the address whitelist is a pre-established list of valid IP addresses, the open platform adds the IP addresses of various third-party applications that already complete platform settlement and successfully go live to the address whitelist in advance, and only the IP addresses in the whitelist have a permission for acquiring the business data; after the open platform acquires the IP address of the data acquisition request, whether the IP address is located in the address whitelist is determined; in the case where the IP address is located in the address whitelist, the subsequent Token information verification of the first user and the identification information verification of the access object are sequentially performed; and in the case where the IP address is not located in the address whitelist, this data acquisition request is not responded, so as to improve the security of the business data.

For example, in the embodiments of the present disclosure, that in the case where the access object has the association relationship with the first user, sending the business data of the access object to the third-party application, includes: in the case where the access object has the association relationship with the first user, acquiring a business association region of the access object and a data acquisition region of the third-party application, and determining whether the business association region of the access object is consistent with the data acquisition region of the third-party application; in the case where the business association region of the access object is consistent with the data acquisition region of the third-party application, sending the business data of the access object to the third-party application.

For example, the open platform may further assign a data acquisition permission to each third-party application within the region where the third-party application is located. For example, in the case where a server B integrated with a third-party application A is located in an region C, the third-party application A may only acquire business data within a range of the region C; in the case where the data acquisition request is acquired, an IP address of the server of the third-party application that sends the data acquisition request is acquired, and the IP address is configured to determine whether the region where the server is located is consistent with a business operation region of the accessed store, or whether it is consistent with a business operation region of the store of the seller party in the accessed order; in the case where the region where the server is located is not consistent with a business operation region of the accessed store, and the region where the server is located is not consistent with the business operation region of the store of the seller party in the accessed order, this data acquisition request is not responded; and in the case where the region where the server is located is consistent with a business operation region of the accessed store, or the region where the server is located is consistent with the business operation region of the store of the seller party in the accessed order, the business data of the accessed store or the accessed order is sent to the third-party application, so as to further improve the security of the business data by comparing the consistency between the belonging region of the third-party application and the business association region of the access object.

S130, in the case where the access object has the association relationship with the first user, sending business data of the access object to the third-party application.

In the case where the data acquisition request passes the Token information verification and the identification information verification of the access object, the open platform sends the corresponding business data of the access object to the third-party application, so as to achieve the transmission of the business data between the open platform and the third-party application.

The technical schemes of the embodiments of the present disclosure, after the data acquisition request sent from the third-party application is acquired, by verifying the Token information of the first user, achieve the identity verification of the first user, avoid the frequent query of the database, reduce the operating pressure of the server, and avoid a potential security risk caused by the third-party application knowing the user's account and password, at the same time, by verifying the identification information of the access object, achieve the matching verification in the access object dimension, further improve the security of the business data, and ultimately, send the business data of the access object to the third-party application, which achieves the transmission of the business data between the open platform and the third-party application.

FIG. 2 is a data management method of the present disclosure, and this embodiment is further refined based on the above embodiments, in the embodiments of the present disclosure, that according to the identification information of the access object, determining whether a target object exists in the access object that has an authorization binding relationship with the third-party application, includes the following steps.

S210, acquiring a data acquisition request sent from the third-party application, in which the data acquisition request includes Token information of the first user and identification information of the access object.

S220, according to the identification information of the access object, determining whether the target object exists in the access object that has an authorization binding relationship with the third-party application.

S230, in the case where the target object that has the authorization binding relationship with the third-party application exists in the access object, sending the business data of the target object to the third-party application.

In the case where a seller user opens a plurality of stores in the current e-commerce platform, and when the third-party application is authorized, some or all of the stores are authorization-bound to the third-party application, and the third-party application only has a permission for acquiring the business data of the store having an authorization binding relationship; when the third-party application sends the data acquisition request to the open platform, identification information of one or more stores having the authorization binding relationship may be added in the data acquisition request, so as to acquire the business data of the above one or more stores; in the case where the buyer user has a plurality of purchase orders in the current e-commerce platform, and when the third-party application is authorized, some or all of the orders are authorization-bound to the third-party application, and the third-party application only has a permission for acquiring the business data of the order having the authorization binding relationship; and when the third-party application sends the data acquisition request to the open platform, identification information of one or more orders having the authorization binding relationship may be added to the data acquisition request, so as to obtain the business data of the above one or more orders. Because the Token information of the first user in the data acquisition request is already verified, it is indicated that the third-party application is already identity-verified from an identity dimension of the first user, and the third-party application already passes the identity verification, therefore, the third-party application already has the management permission of the first user essentially.

After the open platform acquires the identification information of the access object, in the case where a target object that has the association relationship with the first user exists in the above identification information, and the target object has an authorization binding relationship with the third-party application, the business data of the target object is sent to the third-party application, so as to improve the fault tolerance of business data acquisition and avoid invalidation of the data acquisition request due to incorrect identification information of one or a few access objects, which may lead to the failure of the business data acquisition for all access objects; for the remaining objects in the access objects, except for the target object, whether it has the association relationship with the first user but does not have the authorization binding relationship with the third-party application, or does not have the association relationship with the first user, its business data is not sent to the current third-party application, so as to ensure the security of the business data; and in the case where no target object exists in the access object that has the authorization binding relationship with the third-party application, this data acquisition request is not responded.

The technical schemes of the embodiments of the present disclosure, according to the identification information of the access object, after that the target object having the authorization binding relationship with the third-party application exists in the access objects is determined, send the business data of the target object to the third-party application, and the business data of the remaining objects in the access objects is not sent to the third-party application, thereby improving the fault tolerance of business data acquisition and avoiding invalidation of the data acquisition request due to incorrect identification information of one or a few access objects, which may lead to the failure of the business data acquisition for all access objects.

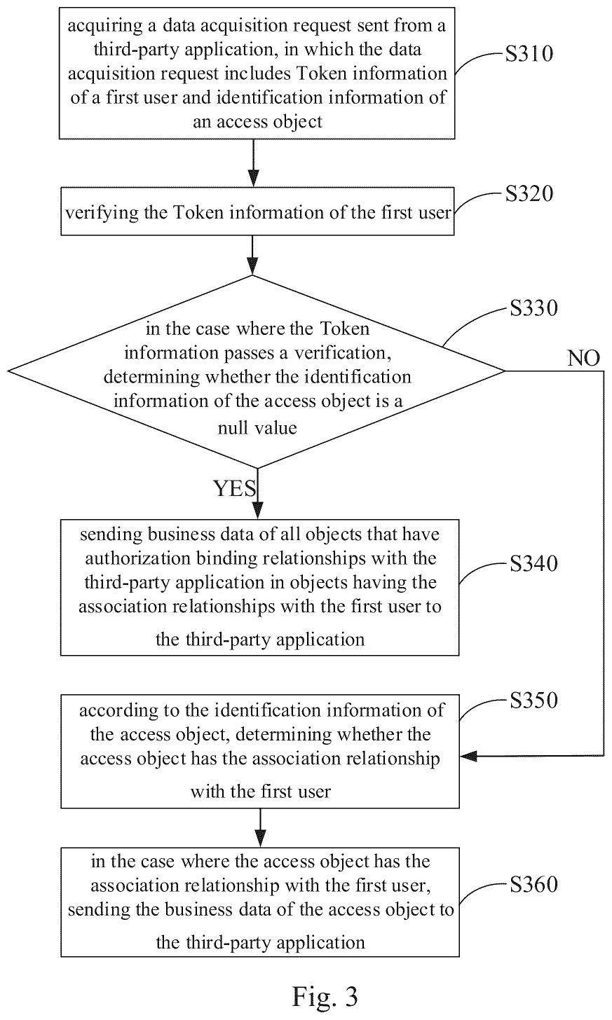

FIG. 3 is a data management method provided in an embodiment of the present disclosure, and this embodiment is refined based on the above embodiments, in the embodiments of the present disclosure, in the case where the identification information of the access object is a null value, business data of all objects that have authorization binding relationships with the third-party application in objects having the association relationships with the first user is sent to the third-party application, and the method includes the following steps.

S310, acquiring a data acquisition request sent from a third-party application, in which the data acquisition request includes Token information of a first user and identification information of an access object; and executing S320.

S320, verifying the Token information of the first user; and executing S330.

S330, in the case where the Token information passes the verification, determining whether the identification information of the access object is a null value; in the case where the identification information of the access object is the null value, executing S340; and in the case where the identification information of the access object is not the null value, executing S350.

S340, sending the business data of all objects that have authorization binding relationships with the third-party application in objects having the association relationships with the first user to the third-party application.

Because the Token information of the first user in the data acquisition request is already verified, which indicates that the third-party application is already identity-verified from an identity dimension of the first user, and the third-party application already passes the identity verification, the third-party application already has the management permission of the first user essentially; therefore, in the case where the identification information is the null value, the business data of all objects that have the authorization binding relationships with the third-party application in the objects having the association relationships with the first user is sent to the third-party application, which avoids that the third-party application needs to put identification information of a plurality of stores one by one into the data acquisition request when there are many access objects, also avoids the open platform from verifying the identification information of the plurality of the stores one by one, and improves the parsing efficiency of the data acquisition request and the transmission efficiency of the business data.

S350, according to the identification information of the access object, determining whether the access object has an association relationship with the first user; and executing S360.

S360, in the case where the access object has the association relationship with the first user, sending the business data of the access object to the third-party application.

The technical schemes of the embodiments of the present disclosure, according to the identification information of the access object, after that the identification information of the access object is determined as the null value, the business data of all objects that have the authorization binding relationships with the third-party application in the objects having the association relationships with the first user is sent to the third-party application, which avoids that the third-party application needs to put identification information of a plurality of access objects one by one into the data acquisition request when there are many access objects, also avoids the open platform from verifying the identification information of the plurality of the access objects one by one, and improves the parsing efficiency of the data acquisition request and the transmission efficiency of the business data.

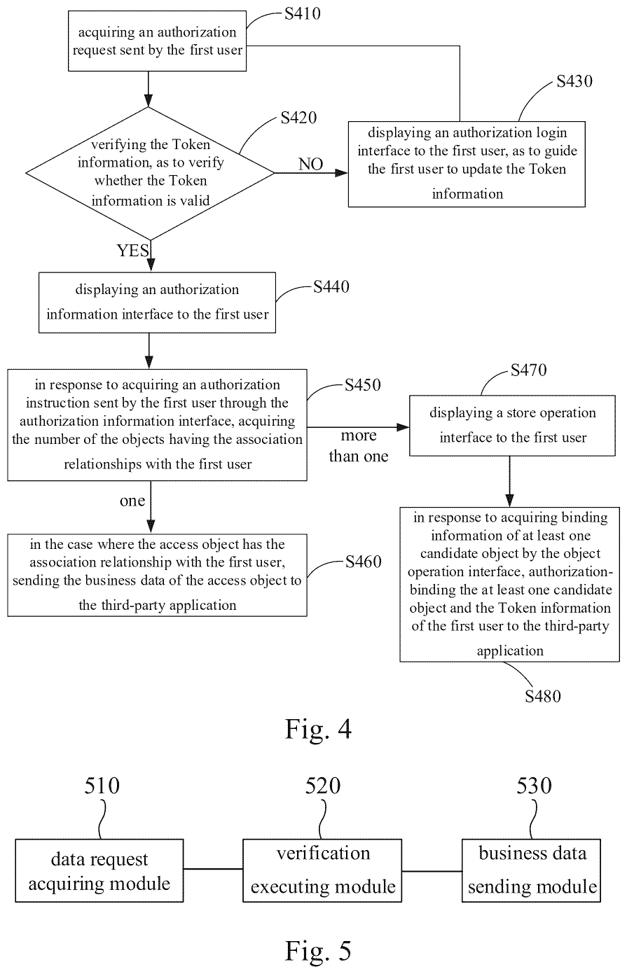

FIG. 4 is a data management method provided in an embodiment of the present disclosure, and this embodiment is refined based on the above embodiments, in the embodiments of the present disclosure, the open platform binds the Token information of the first user and an authorized object to the third-party application, and the method includes the following steps.

S410, acquiring an authorization request sent by the first user, in which the authorization request includes the Token information of the first user and identification information of a third-party application to be authorized; and executing S420.

S420, verifying the Token information, as to verify whether the Token information is valid; in the case where the Token information is invalid, executing S430; and in the case where the Token information is valid, executing S440.

S430, displaying an authorization login interface to the first user, as to guide the first user to update the Token information; and executing S410.

In the case where the Token information is invalid, it may be because the Token information is expired, or it may be because the first user logins for the first time and does not acquire the Token information, at this time, the authorization login interface is jumped to, as to guide the first user to acquire or update the Token information by writing account and password.

S440, displaying an authorization information interface to the first user; and executing S450.

In the case where the Token information of the first user is valid, the authorization information interface is displayed to the first user; the authorization information interface displays the identification information of the third-party application, so as to guide the user to assign the Token information to the current third-party application.

S450, in response to acquiring an authorization instruction sent by the first user through the authorization information interface, acquiring the number of the objects having the association relationships with the first user; in the case where there is one object having the association relationship with the first user, executing S460; and in the case where there are a plurality of the objects having the association relationships with the first user, executing S470.

S460, authorization-binding the object having the association relationship with the first user and the Token information of the first user to the third-party application to be authorized.

In the case where the seller user only opens one store, it is apparent that the store may be directly bound to the current third-party application; and in the case where the buyer user only has one order, the order may also be directly bound to the current third-party application.

S470, displaying a store operation interface to the first user; and executing S480.

S480, in response to acquiring binding information of at least one candidate object by the object operation interface, authorization-binding the at least one candidate object and the Token information of the first user to the third-party application.

In the case where the seller user opens a plurality of stores, the third-party application may be authorization-bound to some or all of the stores by the seller user checking in the store operation interface, and the third-party application only has a permission for acquiring the business data of the store having the authorization binding relationship; and in the case where the buyer user has a plurality of corresponding purchase orders, the third-party application may be authorization-bound to some or all of the orders by the buyer user checking in the order operation interface, and the third-party application only has a permission for acquiring the business data of the order having the authorization binding relationship.

The technical schemes of the embodiments of the present disclosure, after the authorization request sent by the first user is acquired, achieve the identity binding between the third-party application and the first user by verifying the Token information of the first user, the security risk of account and password leakage is avoided when the first user authorizes the third-party application, at the same time, the store binding information of the first user is acquired by the store operation interface, which achieves the third-party application binding in store dimension, and improves the security of the business data.

FIG. 5 is a structure block diagram of a data management apparatus provided in an embodiment of the present disclosure, and includes: a data request acquiring module 510, a verification executing module 520, and a business data sending module 530.

The data request acquiring module 510 is configured to acquire a data acquisition request sent from a third-party application, in which the data acquisition request includes Token information of a first user and identification information of an access object.

The verification executing module 520 is configured to verify the Token information of the first user, in the case where the Token information passes the verification, according to the identification information of the access object, determine whether the access object has an association relationship with the first user.

The business data sending module 530 is configured to, in the case where the access object has the association relationship with the first user, send business data of the access object to the third-party application.

The technical schemes of the embodiments of the present disclosure, after the data acquisition request sent from the third-party application is acquired, by verifying the Token information of the first user, achieve the identity verification of the first user, avoid the frequent query of the database, reduce the operating pressure of the server, and avoid a potential security risk caused by the third-party application knowing the user's account and password, at the same time, by verifying the identification information of the access object, achieve the matching verification in the access object dimension, further improve the security of the business data, and ultimately, send the business data of the access object to the third-party application, which achieves the transmission of the business data between the open platform and the third-party application.

For example, on the basis of the above technical schemes, the data management apparatus further includes at least one of the following:
a first belonging region determining module, which is configured to acquire a sending region of the data acquisition request, and determine whether the sending region is a designated region; and in the case where the sending region is not the designated region, not respond to the data acquisition request;
a second belonging region determining module, which is configured to acquire a belonging region of the access object, and determine whether the belonging region of the access object is the designated region; and in the case where the belonging region of the access object is not the designated region, not respond to the data acquisition request; and
an address whitelist determining module, which is configured to acquire an IP address of the data acquisition request, and determine whether the IP address is located in an address whitelist; and in the case where the IP address is not located in the address whitelist, not respond to the data acquisition request.

For example, based on the above technical schemes, the business data sending module 530 includes:
a region consistency determining unit, which is configured to, in the case where the access object has the association relationship with the first user, acquire a business association region of the access object and a data acquisition region of the third-party application, and determine whether the business association region of the access object is consistent with the data acquisition region of the third-party application; and
a business data sending unit, which is configured to, in the case where the business association region of the access object is consistent with the data acquisition region of the third-party application, send the business data of the access object to the third-party application.

For example, based on the above technical schemes, the verification executing module 520 is configured to, according to the identification information of the access object, determine whether there is a target object in the access object that has an authorization binding relationship with the third-party application;

The business data sending module 530 is configured to, in the case where there is the target object in the access object that has the authorization binding relationship with the third-party application, send the business data of the target object to the third-party application.

For example, based on the above technical schemes, the data management apparatus further includes:
a null value determining module, which is configured to determine whether the identification information of the accessed object is a null value.

For example, based on the above technical schemes, the business data sending module 530 is further configured to, in the case where the identification information of the access object is the null value, send business data of all objects that have authorization binding relationships with the third-party application in objects having the association relationships with the first user to the third-party application.

For example, based on the above technical schemes, the verification executing module 520 is configured to, in the case where the identification information of the access object is not the null value, according to the identification information of the access object, determine whether the access object has the association relationship with the first user.

For example, based on the above technical schemes, the data management apparatus further includes:
an authorization request acquiring module, which is configured to acquire an authorization request sent by the first user; wherein the authorization request includes the Token information of the first user and identification information of the third-party application to be authorized;
a Token verification executing module, which is configured to verify the Token information, as to verify whether the Token information is valid;
an authorization login interface displaying module, which is configured to, in the case where the Token information is invalid, display an authorization login interface to the first user, as to guide the first user to update the Token information;
an authorization information interface displaying module, which is configured to, in the case where the Token information is valid, display an authorization information interface to the first user.
an object number acquiring module, which is configured to, in response to acquiring an authorization instruction sent by the first user through the authorization information interface, acquire the number of the objects having the association relationships with the first user; and
a first authorization binding executing module, which is configured to, in the case where there is one object having the association relationship with the first user, authorization-bind the object having the association relationship with the first user and the Token information of the first user to the third-party application to be authorized.

For example, based on the above technical schemes, the data management apparatus further includes:
an object operation interface displaying module, which is configured to, in the case where there are a plurality of the objects having the association relationships with the first user, display an object operation interface to the first user; and
a second authorization binding executing module, which is configured to, in response to acquiring binding information of at least one candidate object by the object operation interface, authorization-bind the at least one candidate object and the Token information of the first user to the third-party application.

The above apparatus may execute the data management method provided in any embodiments of the present disclosure, and has corresponding functional modules and beneficial effects for executing the method. Technical details that are not described in detail in this embodiment may be found in the methods provided in any embodiments of the present disclosure.

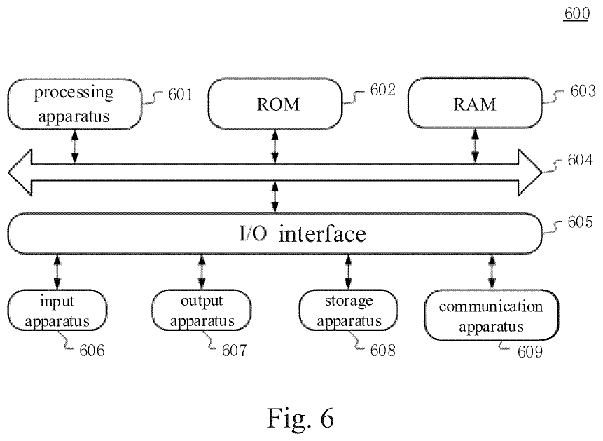

FIG. 6 shows a structure schematic diagram of a server 600 suitable for implementing embodiments of the present disclosure. A terminal device in the embodiment of the present disclosure may include but not limited to a mobile terminal such as a mobile phone, a notebook computer, a digital radio broadcasting receiver, a personal digital assistant (PDA), a portable android device (PAD), a portable multimedia player (PMP), a vehicle terminal (such as a vehicle navigation terminal), and a fixed terminal such as a digital television (TV) and a desktop computer. The server shown in FIG. 6 is only an example and should not impose any limitations on the functions and usage scopes of the embodiments of the present disclosure.

As shown in FIG. 6, the server 600 may include a processing apparatus (such as a central processing unit, a graphics processor, and the like) 601, which may execute various appropriate actions and processes according to a program stored in a read-only memory (ROM) 602 or a program loaded from a storage apparatus 608 to a random-access memory (RAM) 603. In the RAM 603, various programs and data required for operations of the server 600 are further stored. The processing apparatus 601, the ROM 602, and the RAM 603 are connected to each other by a bus 604. An input/output (I/O) interface 605 is also connected to the bus 604.

Generally, the following apparatuses may be connected to the I/O interface 605: an input apparatus 606 such as a touch screen, a touch pad, a keyboard, a mouse, a camera, a microphone, an accelerometer, a gyroscope, etc.; an output apparatus 607 such as a liquid crystal display (LCD), a loudspeaker, a vibrator, etc.; a storage apparatus 608 such as a magnetic tape, and a hard disk, etc.; and a communication apparatus 609. The communication apparatus 609 may allow the server 600 to perform wireless or wire communication with other devices to exchange data. Although FIG. 6 shows the server 600 with various apparatuses, it should be understood that it is not required to implement or possess all the apparatuses shown. It may implement alternatively or possess the more or less apparatuses.

According to the embodiment of the present disclosure, the process described above with reference to the flowcharts may be achieved as a computer software program. For example, an embodiment of the present disclosure includes a computer program product, the computer program product includes a computer program loaded on a non-transitory computer-readable medium, and the computer program contains program codes for executing the method shown in the flowcharts. In such an embodiment, the computer program may be downloaded and installed from the network by the communication apparatus 609, or installed from the storage apparatus 608, or installed from ROM 602. When the computer program is executed by the processing apparatus 601, the above functions in the method in the embodiments of the present disclosure are executed.

It should be noted that the computer-readable medium mentioned above in the present disclosure may be a computer-readable signal medium or a computer-readable storage medium or any combination thereof. The computer-readable storage medium may be, for example, but not limited to, an electrical, magnetic, optical, electromagnetic, infrared, or semiconductor system, device or device, or any combination thereof. More specific examples of the computer-readable storage medium may include, but not limited to: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium containing or storing a program that may be used by or in combination with an instruction execution system, device or device. In the present disclosure, the computer-readable signal medium may include a data signal propagated in a baseband or as a part of a carrier wave, in which computer-readable program codes are carried. This propagated data signal may take multiple forms, including but not limited to an electromagnetic signal, an optical signal or any suitable combination of the above. The computer-readable signal medium may also be any computer-readable medium other than the computer-readable storage medium, and may send, propagate or transmit a program used by or in combination with an instruction execution system, device or device. The program codes contained on the computer-readable medium may be transmitted by any suitable medium, including but not limited to: an electric wire, a fiber-optic cable, radio frequency (RF) and the like, or any suitable combination of the above.

In some implementation methods, a client and the server can communicate by using any currently known or future developed network protocol such as a hypertext transfer protocol (HTTP), and may communicate and interconnect with digital data in any form or medium (for example, a communication network). Examples of the communication network include a local area network (“LAN”), a wide area network (“WAN”), the Internet work (for example, the Internet) and an end-to-end network (for example, an ad hoc end-to-end network), as well as any currently known or to be researched and developed in the future.

The above computer-readable medium may be contained in the above server; and it may also exist separately without being assembled into the server.

The above computer-readable medium carries one or more programs, and when the above one or more programs are executed by the server, the server: acquires a data acquisition request sent from a third-party application; herein, the data acquisition request includes Token information of a first user and identification information of an access object; verifies the Token information of the first user, in the case where the Token information passes the verification, according to the identification information of the access object, determines whether the access object has an association relationship with the first user; and in the case where the access object has the association relationship with the first user, sends business data of the access object to the third-party application.

Computer program codes for performing the operations of the present disclosure may be written in one or more programming languages or a combination thereof, the programming languages include, but are not limited to, object-oriented programming languages such as Java, Smalltalk and C++, and further include conventional procedural programming languages such as “C” programming language or similar programming languages. The program codes may be entirely executed on a user's computer, partially executed on the user's computer, executed as an independent software package, partially executed on the user's computer and partially executed on a remote computer, or entirely executed on the remote computer or a server. In the case involving the remote computer, the remote computer may be connected to the user's computer through any type of network, including a local area network (LAN) or a wide area network (WAN), or may be connected to an external computer (for example, through the Internet using an Internet service provider).

The flowcharts and block diagrams in the accompanying drawings illustrate the architecture, function and operation of possible implementations of the systems, methods and the computer program product according to various embodiments of the present disclosure. In this regard, each block in the flowcharts or block diagrams may represent a module, a program segment, or a part of codes, which includes one or more executable instructions for implementing specified logical functions. It should also be noted that, in some alternative implementations, the functions noted in the blocks may occur out of the order noted in the accompanying drawings. For example, two blocks illustrated in succession may, in fact, be executed substantially in parallel, and may sometimes be executed in a reverse order, depending on the function involved. It should also be noted that, each block in the block diagrams and/or flowcharts, and combinations of blocks in the block diagrams and/or flow diagrams, may be implemented by a dedicated hardware-based system that performs specified functions or operations, or by a combination of dedicated hardware and computer instructions.

The involved modules described in the embodiments of the present disclosure may be implemented by a mode of software, or may be implemented by a mode of hardware. Herein, the name of the module does not constitute a limitation on the module itself in a certain situation, for example:

The data request acquiring module may be described as “a module used for acquiring a data acquisition request sent from a third-party application”. The functions described above in this article may be at least partially executed by one or more hardware logic components. For example, non-restrictive exemplary types of the hardware logic component that may be used include: a field programmable gate array (FPGA), an application specific integrated circuit (ASIC), an application specific standard product (ASSP), a system on chip (SOC), a complex programmable logic device (CPLD) and the like.

In the context of the present disclosure, the machine-readable medium may be a tangible medium that may include or store a program used by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, device or device, or any suitable combination of the above. More specific examples of the machine-readable storage medium may include an electrical connection based on one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

According to one or more embodiments of the present disclosure, [Example 1] provides a data management method, which includes:
acquiring a data acquisition request sent from a third-party application; in which the data acquisition request includes Token information of a first user and identification information of an access object;
verifying the Token information of the first user, in the case where the Token information passes a verification, according to the identification information of the access object, determining whether the access object has an association relationship with the first user; and
in the case where the access object has the association relationship with the first user, sending business data of the access object to the third-party application.

According to one or more embodiments of the present disclosure, [Example 2] provides a data management method of example 1, that after acquiring the data acquisition request sent from the third-party application, the method further includes at least one of the following:
acquiring a sending region of the data acquisition request, and determining whether the sending region is a designated region;
in the case where the sending region is not the designated region, not responding to the data acquisition request;
acquiring a belonging region of the access object, and determining whether the belonging region of the access object is the designated region;
in the case where the belonging region of the access object is not the designated region, not responding to the data acquisition request;
acquiring an IP address of the data acquisition request, and determining whether the IP address is located in an address whitelist; and
in the case where the IP address is not located in the address whitelist, not responding to the data acquisition request.

According to one or more embodiments of the present disclosure, [Example 3] provides a data management method of example 1, in which in response to determining that the access object has the association relationship with the first user, sending business data of the access object to the third-party application, includes:
in the case where the access object has the association relationship with the first user, acquiring a business association region of the access object and a data acquisition region of the third-party application, and determining whether the business association region of the access object is consistent with the data acquisition region of the third-party application; and
in the case where the business association region of the access object is consistent with the data acquisition region of the third-party application, sending the business data of the access object to the third-party application.

According to one or more embodiments of the present disclosure, [Example 4] provides a data management method of example 1, in which the according to the identification information of the access object, determining whether the access object has an association relationship with the first user, includes:
according to the identification information of the access object, determining whether a target object exists in the access object that has an authorization binding relationship with the third-party application; and
in the case where the target object that has the authorization binding relationship with the third-party application exists in the access object, sending the business data of the target object to the third-party application.

According to one or more embodiments of the present disclosure, [Example 5] provides a data management method of example 1, in which before the according to the identification information of the access object, determining whether the access object has an association relationship with the first user, the method further includes:
determining whether the identification information of the access object is a null value;
in the case where the identification information of the access object is the null value, sending business data of all objects that have authorization binding relationships with the third-party application in objects having the association relationships with the first user to the third-party application; and
in the case where the identification information of the access object is not the null value, according to the identification information of the access object, determining whether the access object has the association relationship with the first user.

According to one or more embodiments of the present disclosure, [Example 6] provides a data management method of example 1, which further includes:
acquiring an authorization request sent by the first user; in which the authorization request includes the Token information of the first user and identification information of the third-party application to be authorized;
verifying the Token information, as to verify whether the Token information is valid;
in the case where the Token information is invalid, displaying an authorization login interface to the first user, as to guide the first user to update the Token information;
in the case where the Token information is valid, displaying an authorization information interface to the first user;
in response to acquiring an authorization instruction sent by the first user through the authorization information interface, acquiring the number of objects having the association relationships with the first user; and
in response to determining that one object having the association relationship with the first user, authorization-binding the object having the association relationship with the first user and the Token information of the first user to the third-party application to be authorized.

According to one or more embodiments of the present disclosure, [Example 7] provides a data management method of example 6, in which after the acquiring the number of objects having the association relationships with the first user, the method further includes:
in the case where a plurality of the objects having the association relationships with the first user, displaying an object operation interface to the first user; and
in response to acquiring binding information of at least one candidate object by the object operation interface, authorization-binding the at least one candidate object and the Token information of the first user to the third-party application.

According to one or more embodiments of the present disclosure, [Example 8] provides a data management apparatus, which includes:
a data request acquiring module, configured to acquire a data acquisition request sent from a third-party application; in which the data acquisition request includes Token information of a first user and identification information of an access object;
a verification executing module, configured to verify the Token information of the first user, in response to that the Token information passes a verification, according to the identification information of the access object, determine whether the access object has an association relationship with the first user; and
a business data sending module, configured to, based on a determining result that the access object has the association relationship with the first user, send business data of the access object to the third-party application.

According to one or more embodiments of the present disclosure, [Example 9] provides a data management apparatus of example 8, which includes at least one of the following:
a first belonging region determining module, which is configured to acquire a sending region of the data acquisition request, and determine whether the sending region is a designated region; and in the case where the sending region is not the designated region, not respond to the data acquisition request;
a second belonging region determining module, which is configured to acquire a belonging region of the access object, and determine whether the belonging region of the access object is the designated region; and in the case where the belonging region of the access object is not the designated region, not respond to the data acquisition request; and
an address whitelist determining module, which is configured to acquire an IP address of the data acquisition request, and determine whether the IP address is located in an address whitelist; and in the case where the IP address is not located in the address whitelist, not respond to the data acquisition request.

According to one or more embodiments of the present disclosure, [Example 10] provides a data management apparatus of example 8, the business data sending module includes:
a region consistency determining unit, which is configured to, in the case where the access object has the association relationship with the first user, acquire a business association region of the access object and a data acquisition region of the third-party application, and determine whether the business association region of the access object is consistent with the data acquisition region of the third-party application; and
a business data sending unit, which is configured to, in the case where the business association region of the access object is consistent with the data acquisition region of the third-party application, send the business data of the access object to the third-party application.

According to one or more embodiments of the present disclosure, [Example 11] provides a data management apparatus of example 8, the verification executing module 520 is configured to, according to the identification information of the access object, determine whether there is a target object in the access object that has an authorization binding relationship with the third-party application;

The business data sending module 530 is configured to, in the case where there is the target object in the access object that has the authorization binding relationship with the third-party application, send the business data of the target object to the third-party application.

According to one or more embodiments of the present disclosure, [Example 12] provides a data management apparatus of example 8, which further includes:
a null value determining module, which is configured to determine whether the identification information of the accessed object is a null value.

The business data sending module is further configured to, in the case where the identification information of the access object is the null value, send business data of all objects that have authorization binding relationships with the third-party application in objects having the association relationships with the first user to the third-party application.

The verification executing module is configured to, in the case where the identification information of the access object is not the null value, according to the identification information of the access object, determine whether the access object has the association relationship with the first user.

According to one or more embodiments of the present disclosure, [Example 13] provides a data management apparatus of example 8, which further includes:
an authorization request acquiring module, which is configured to acquire an authorization request sent by the first user; wherein the authorization request includes the Token information of the first user and identification information of the third-party application to be authorized;
a Token verification executing module, which is configured to verify the Token information, as to verify whether the Token information is valid;
an authorization login interface displaying module, which is configured to, in the case where the Token information is invalid, display an authorization login interface to the first user, as to guide the first user to update the Token information;
an authorization information interface displaying module, which is configured to, in the case where the Token information is valid, display an authorization information interface to the first user.
an object number acquiring module, which is configured to, in response to acquiring an authorization instruction sent by the first user through the authorization information interface, acquire the number of the objects having the association relationships with the first user; and
a first authorization binding executing module, which is configured to, in the case where there is one object having the association relationship with the first user, authorization-bind the object having the association relationship with the first user and the Token information of the first user to the third-party application to be authorized.

According to one or more embodiments of the present disclosure, [Example 14] provides a data management apparatus of example 13, which further includes:
an object operation interface displaying module, which is configured to, in the case where there are a plurality of the objects having the association relationships with the first user, display an object operation interface to the first user; and
a second authorization binding executing module, which is configured to, in response to acquiring binding information of at least one candidate object by the object operation interface, authorization-bind the at least one candidate object and the Token information of the first user to the third-party application.

According to one or more embodiments of the present disclosure, [Example 15] provides a server, which includes a memory, a processing apparatus, and a computer program stored in the memory and can be run in the processing apparatus, the data management method according to any one of examples 1-7 is implemented in the case where the processing apparatus executes the program.

According to one or more embodiments of the present disclosure, [Example 16] provides a storage medium containing a computer executable instruction, the data management method according to any one of examples 1-7 is implemented in the case where the computer executable instruction is executed by a computer processor.

Furthermore, although various operations are depicted in a particular order, this should not be understood as requiring that these operations be performed in the particular order shown or in a sequential order. Under certain circumstances, multitasking and parallel processing may be beneficial. Likewise, although several specific implementation details are contained in the above discussion, these should not be construed as limiting the scope of the present disclosure. Some features described in the context of separate embodiments can also be combined in a single embodiment. On the contrary, various features described in the context of a single embodiment can also be implemented in multiple embodiments individually or in any suitable sub-combination.

1. A data management method, comprising:
acquiring a data acquisition request sent from a third-party application; wherein the data acquisition request comprises Token information of a first user and identification information of an access object;
verifying the Token information of the first user, in response to that the Token information passes a verification, according to the identification information of the access object, determining whether the access object has an association relationship with the first user; and
based on a determining result that the access object has the association relationship with the first user, sending business data of the access object to the third-party application.

2. The method according to claim 1, after acquiring the data acquisition request sent from the third-party application, further comprising at least one of the following:
acquiring a sending region of the data acquisition request, and determining whether the sending region is a designated region;
based on a determining result that the sending region is not the designated region, not responding to the data acquisition request;
acquiring a belonging region of the access object, and determining whether the belonging region of the access object is the designated region;
based on a determining result that the belonging region of the access object is not the designated region, not responding to the data acquisition request;
acquiring an IP address of the data acquisition request, and determining whether the IP address is located in an address whitelist; and
based on a result that the IP address is not located in the address whitelist, not responding to the data acquisition request.

3. The method according to claim 1, wherein in response to determining that the access object has the association relationship with the first user, sending business data of the access object to the third-party application, comprises:
in response to determining that the access object has the association relationship with the first user, acquiring a business association region of the access object and a data acquisition region of the third-party application, and determining whether the business association region of the access object is consistent with the data acquisition region of the third-party application; and
based on a determining result that the business association region of the access object is consistent with the data acquisition region of the third-party application, sending the business data of the access object to the third-party application.

4. The method according to claim 1, wherein the according to the identification information of the access object, determining whether the access object has an association relationship with the first user, comprises:
according to the identification information of the access object, determining whether a target object exists in the access object that has an authorization binding relationship with the third-party application; and
in response to determining that the access object has the association relationship with the first user, sending business data of the access object to the third-party application, comprises:
in response to that the target object that has the authorization binding relationship with the third-party application exists in the access object, sending the business data of the target object to the third-party application.

5. The method according to claim 1, wherein before the according to the identification information of the access object, determining whether the access object has an association relationship with the first user, further comprises:
determining whether the identification information of the access object is a null value;
based on a determining result that the identification information of the access object is the null value, sending business data of all objects that have authorization binding relationships with the third-party application in objects having the association relationships with the first user to the third-party application; and
the according to the identification information of the access object, determining whether the access object has an association relationship with the first user, comprises:
based on a determining result that the identification information of the access object is not the null value, according to the identification information of the access object, determining whether the access object has the association relationship with the first user.

6. The method according to claim 1, further comprising:
acquiring an authorization request sent by the first user; wherein the authorization request comprises the Token information of the first user and identification information of the third-party application to be authorized;
verifying the Token information, as to verify whether the Token information is valid;
in response to that the Token information is invalid, displaying an authorization login interface to the first user, as to guide the first user to update the Token information;
in response to that the Token information is valid, displaying an authorization information interface to the first user;
in response to acquiring an authorization instruction sent by the first user through the authorization information interface, acquiring the number of objects having the association relationships with the first user; and
in response to determining that one object having the association relationship with the first user, authorization-binding the object having the association relationship with the first user and the Token information of the first user to the third-party application to be authorized.

7. The method according to claim 6, wherein after the acquiring the number of objects having the association relationships with the first user, further comprises:
in response to that a plurality of the objects having the association relationships with the first user, displaying an object operation interface to the first user; and
in response to acquiring binding information of at least one candidate object by the object operation interface, authorization-binding the at least one candidate object and the Token information of the first user to the third-party application.

8. (canceled)

9. A server, comprising a memory, a processing apparatus, and a computer program stored in the memory and can be run in the processing apparatus, wherein in the case where the processing apparatus executes the program, the processing apparatus implements:
acquiring a data acquisition request sent from a third-party application; wherein the data acquisition request comprises Token information of a first user and identification information of an access object;
verifying the Token information of the first user, in response to that the Token information passes a verification, according to the identification information of the access object, determining whether the access object has an association relationship with the first user; and
based on a determining result that the access object has the association relationship with the first user, sending business data of the access object to the third-party application.

10. A storage medium containing a computer executable instruction, wherein in the case where the computer executable instruction is executed by a computer processor, the computer executable instruction is configured to execute:
acquiring a data acquisition request sent from a third-party application; wherein the data acquisition request comprises Token information of a first user and identification information of an access object;
verifying the Token information of the first user, in response to that the Token information passes a verification, according to the identification information of the access object, determining whether the access object has an association relationship with the first user; and
based on a determining result that the access object has the association relationship with the first user, sending business data of the access object to the third-party application.

11. The server according to claim 9, wherein in the case where the processing apparatus executes the program, the processing apparatus further implements at least one of the following:
acquiring a sending region of the data acquisition request, and determining whether the sending region is a designated region;
based on a determining result that the sending region is not the designated region, not responding to the data acquisition request;
acquiring a belonging region of the access object, and determining whether the belonging region of the access object is the designated region;
based on a determining result that the belonging region of the access object is not the designated region, not responding to the data acquisition request;
acquiring an IP address of the data acquisition request, and determining whether the IP address is located in an address whitelist; and
based on a result that the IP address is not located in the address whitelist, not responding to the data acquisition request.

12. The server according to claim 9, wherein in the case where the processing apparatus executes the program, the processing apparatus further implements:
in response to determining that the access object has the association relationship with the first user, acquiring a business association region of the access object and a data acquisition region of the third-party application, and determining whether the business association region of the access object is consistent with the data acquisition region of the third-party application; and
based on a determining result that the business association region of the access object is consistent with the data acquisition region of the third-party application, sending the business data of the access object to the third-party application.

13. The server according to claim 9, wherein in the case where the processing apparatus executes the program, the processing apparatus further implements:
according to the identification information of the access object, determining whether a target object exists in the access object that has an authorization binding relationship with the third-party application; and
in response to that the target object that has the authorization binding relationship with the third-party application exists in the access object, sending the business data of the target object to the third-party application.

14. The server according to claim 9, wherein in the case where the processing apparatus executes the program, the processing apparatus further implements:
determining whether the identification information of the access object is a null value;
based on a determining result that the identification information of the access object is the null value, sending business data of all objects that have authorization binding relationships with the third-party application in objects having the association relationships with the first user to the third-party application; and
based on a determining result that the identification information of the access object is not the null value, according to the identification information of the access object, determining whether the access object has the association relationship with the first user.

15. The server according to claim 9, wherein in the case where the processing apparatus executes the program, the processing apparatus further implements:
acquiring an authorization request sent by the first user; wherein the authorization request comprises the Token information of the first user and identification information of the third-party application to be authorized;
verifying the Token information, as to verify whether the Token information is valid;
in response to that the Token information is invalid, displaying an authorization login interface to the first user, as to guide the first user to update the Token information;
in response to that the Token information is valid, displaying an authorization information interface to the first user;
in response to acquiring an authorization instruction sent by the first user through the authorization information interface, acquiring the number of objects having the association relationships with the first user; and
in response to determining that one object having the association relationship with the first user, authorization-binding the object having the association relationship with the first user and the Token information of the first user to the third-party application to be authorized.

16. The server according to claim 15, wherein in the case where the processing apparatus executes the program, the processing apparatus further implements:
in response to that a plurality of the objects having the association relationships with the first user, displaying an object operation interface to the first user; and
in response to acquiring binding information of at least one candidate object by the object operation interface, authorization-binding the at least one candidate object and the Token information of the first user to the third-party application.
